(19) United States
(12) Patent Application Publication
(10) Pub. No.: US 2008/0256764 A1
(43) Pub. Date: Oct. 23, 2008

(54) CLIP MODULE

(75) Inventor: Ching-Yu Hsu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AMA Precision Inc., Taipei (TW)

(21) Appl. No.: 12/104,454

(22) Filed: Apr. 17, 2008

(30) Foreign Application Priority Data
Apr. 20, 2007 (TW) 96113972

(51) Int. Cl. F16B 2/20

(52) U.S. Cl. 24/457

(57) ABSTRACT

A clip module for fixing a heat dissipation element on a base is disclosed. The clip module includes a body, two pressing elements, a fastener and two linkage elements. The body has a pressing part and a pivot part. The pivot part is located at one end of the body. Each pressing element has a first linkage point, and one end of the pressing elements is coupled to the pivot part. The fastener is suitable to be fastened to the base, and has two second linkage points. The linkage elements connect the first linkage points and the second linkage points. The pressing elements rotate around the pivot part to drive the linkage elements to respectively rotate around the corresponding second linkage points so that the fastener is fastened to the base, and the pressing part presses against the heat dissipation element.

### CROSS-REFERENCE TO RELATED APPLICATION

This application claims the priority benefit of Taiwan application serial no. 96113972, filed on Apr. 20, 2007. The entirety the above-mentioned patent application is hereby incorporated by reference herein and made a part of specification.

### BACKGROUND OF THE INVENTION

1. Field of the Invention

The invention relates to a clip module and, more particularly, to a clip module which is used for fixing a heat dissipation apparatus.

2. Description of the Related Art

In recent years, along with the enormous progress of the science and technology, the number of transistors included in various type of electronic components becomes larger and larger, and then the working temperature of the electronic components becomes higher and higher. Taking a central processing unit (CPU) of a computer as an example, since the operating speed of the CPU is continuously increased, the heat generating power of the CPU also continuously rises. To prevent the CPU from being overheated and the computer from loosing effectiveness temporarily or permanently, the computer needs to have sufficient heat dissipation ability to enable the CPU to work normally. To dissipate the heat energy generated by the CPU which is computing in a high speed and to make the CPU maintain the normal state when the CPU is computing in the high speed, in the conventional technology, a heat dissipation apparatus is directly assembled on the CPU (or other heat sources) to make the heat energy generated by the CPU rapidly dissipated to the ambient environment via the heat dissipation apparatus.

FIG. 1A is a three-dimensional schematic diagram showing a conventional heat dissipation apparatus which is assembled to a heat source, and FIG. 1B is an exploded diagram showing the heat dissipation apparatus and the heat source in FIG. 1A. Please refer to FIG. 1A and FIG. 1B. A conventional heat dissipation apparatus 100 is used to be assembled in a computer host to dissipate the heat for a heat source 10 (such as a CPU). The heat dissipation apparatus 100 includes a retention module (RM) 110 which is provided around the heat source 10, a heat sink 120 and a clip module 130. The heat sink 120 is provided on the heat source 10 to dissipate the heat for the heat source 10, and the clip module 130 is provided across the heat sink 120 and applies a downward pressure to the heat sink 120 to make the heat sink 120 tightly attached to the heat source 10. In this way, the heat energy generated by the heat source 10 can be conducted to the heat sink 120, and further be dissipated to the ambient environment via the heat sink 120.

In the conventional technology, the clip module 130 includes a body 132, a fastener 134 and a cam pressing element 136. The body 132 is provided across the heat sink 120, and is suitable to press the heat sink 120 to make the heat sink 120 tightly attached to the heat source 10. One end of the body 132 is fastened to a hook 112 of the RM 110, and the fastener 134 is connected to the other end of the body 132 and is suitable to be fastened to another hook 114 of the RM 110. In addition, the cam pressing element 136 is pivotally connected to the fastener 134 via a bolt 138 to make the cam pressing element 136 rotate around the axis L (X axis) of the bolt 138 and further apply a downward pressure to the body 132.

Since the cam pressing element has only one force applying point, which makes force application difficult, and the stress is excessively concentrated on the cam pressing element, developing a new clip module is needed to be done and is the emphasis of the invention.

### BRIEF SUMMARY OF THE INVENTION

The invention provides a clip module used for fixing a heat dissipation element to a heat source steadily.

The invention provides a clip module which is applied to fix a heat dissipation element on a base. The clip module includes a body, two pressing elements, a fastener and two linkage elements. The body has a pressing part and a pivot part, wherein the pressing part is suitable to press the heat dissipation element, and the pivot part is located at one end of the body. The pressing element has a first linkage point, and one end of each of the two pressing elements is coupled to the pivot part. The fastener is suitable to be fastened to the base and has two second linkage points. The linkage elements connect the first linkage points and the second linkage points, respectively. The pressing elements rotate around the pivot part to drive the linkage elements to rotate around the corresponding second linkage points so that the fastener is fastened to the base and the pressing part presses the heat dissipation element.

In one embodiment of the invention, the above base has a first fastening part, and another end of the body which is opposite to the pivot part has a third fastening part, and the third fastening part is fastened to the first fastening part.

In one embodiment of the invention, the above first fastening part has two hooks, and the third fastening part has two fastening holes which are suitable to be fastened with the hooks.

In one embodiment of the invention, the above base has a second fastening part, and the fastener has a corresponding fourth fastening part which is fastened to the second fastening part.

In one embodiment of the invention, the above second fastening part has two hooks, and the fourth fastening part has two fastening holes which are suitable to be fastened with the hooks.

In one embodiment of the invention, the above fastener has a slide slot which is located between the two linkage points, and the pivot part slides in the slide slot when the pressing elements relatively rotate around the pivot part so that the fastener is fastened to the base.

Since the invention utilizes pressing elements to drive these linkage elements to relatively rotate around these second linkage points to make the fastener move to a locking position from a release position, a user can apply force easily, and a clip module can also make a heat dissipation element fixed to a heat source with relatively uniform external force.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1A is a three-dimensional schematic diagram showing a conventional heat dissipation apparatus which is assembled to a heat source.

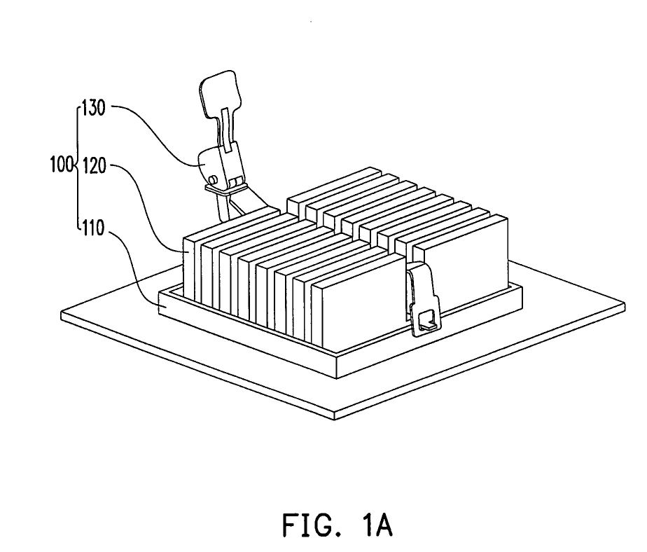

FIG. 1B is an exploded diagram showing the heat dissipation apparatus and the heat source in FIG. 1A.

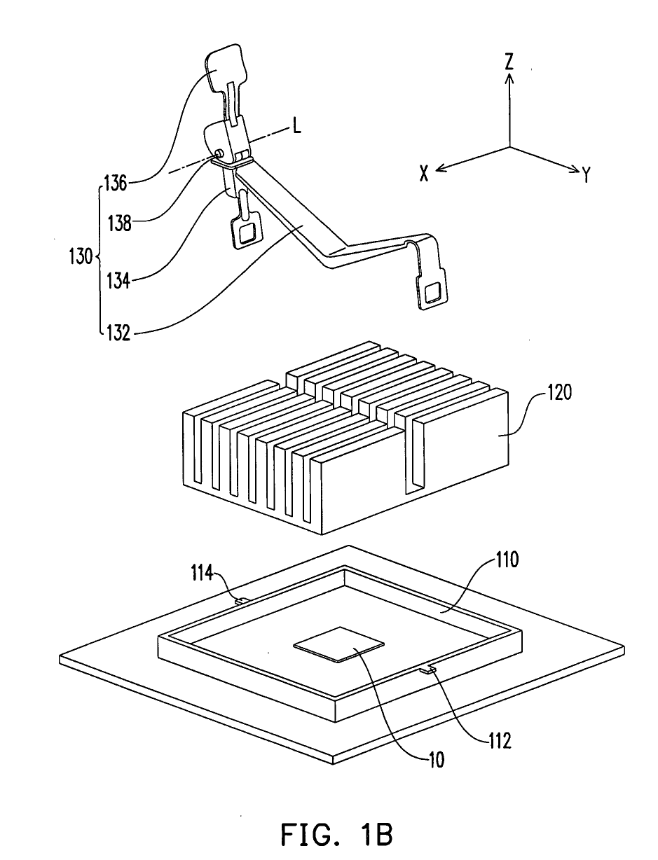

FIG. 2 is a structural schematic diagram showing a clip module which fixes a heat dissipation element to a base according to an embodiment of the invention.

FIG. 3 is a three-dimensional schematic diagram showing the clip module in FIG. 2.

FIG. 4A and FIG. 4B are front view diagrams showing the fastener in FIG. 3, which is located at a release position and a locking position, respectively.

### DETAILED DESCRIPTION OF THE EMBODIMENTS

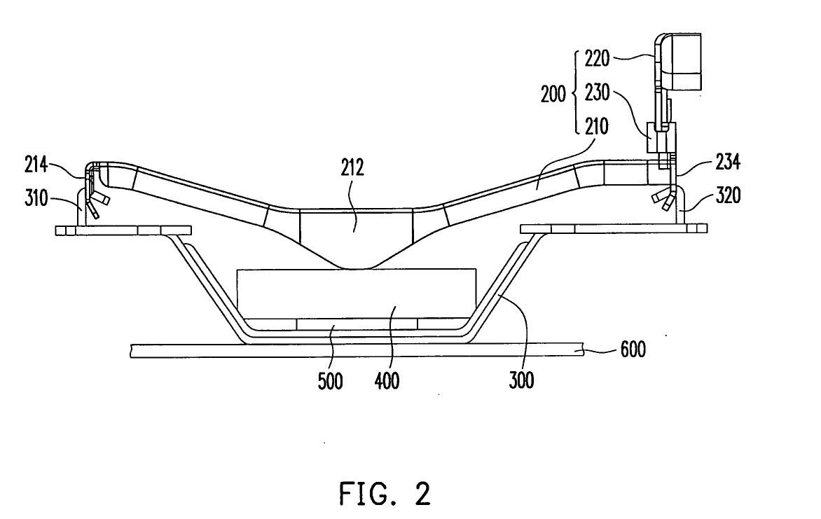

FIG. 2 is a structural schematic diagram showing a clip module which fixes a heat dissipation element to a base according to an embodiment of the invention. Please refer to FIG. 2. A clip module 200 is suitable to cooperate with a base which has a first fastening part 310 and a second fastening part 320 to fix a heat dissipation element 400 to a heat source 500. A third fastening part 214 and a fourth fastening part 234 of the clip module 200 are suitable to be fastened to the first fastening part 310 and the second fastening part 320 of the base 300, respectively. Then, a user can push the two opposite pressing elements 220 of the clip module 200 to rotate, so that the pressing elements 220 drive one fastener 230 of the clip module 200 to be fastened to the base 300, and one pressing part 212 of the clip module 200 presses against the heat dissipation element 400 to fix the heat dissipation element 400 on the heat source 500.

In the embodiment, the base 300 is, for example, a retention module provided on a printed circuit board 600. The heat dissipation element 400 is, for example, an extrusion heat sink, a radiating fin or heat dissipation elements with other appropriate type. The heat source 500 is, for example, the central processing unit (CPU) provided on the circuit board 600.

In the embodiment, since the base 300 has the first fastening part 310 and the second fastening part 320, the clip module 200 can be assembled to the base 300 by fastening the third fastening part 214 and the fourth fastening part 234 of the clip module 200 to the first fastening part 310 and the second fastening part 320 of the base 300, respectively. However, the mode of assembling the clip module 200 to the base 300 is not limited by the method of fastening corresponding fastening parts to each other. For example, one end of the clip module 200 can be connected to one side of the base 300 via a pivotal connecting mode, and the other end of the clip module 200 can be assembled to the other side of the base 300 via a fastening part. Therefore, the embodiment only is an example to illustrate that the invention can be carried out and is not used to limit the scope of the invention.

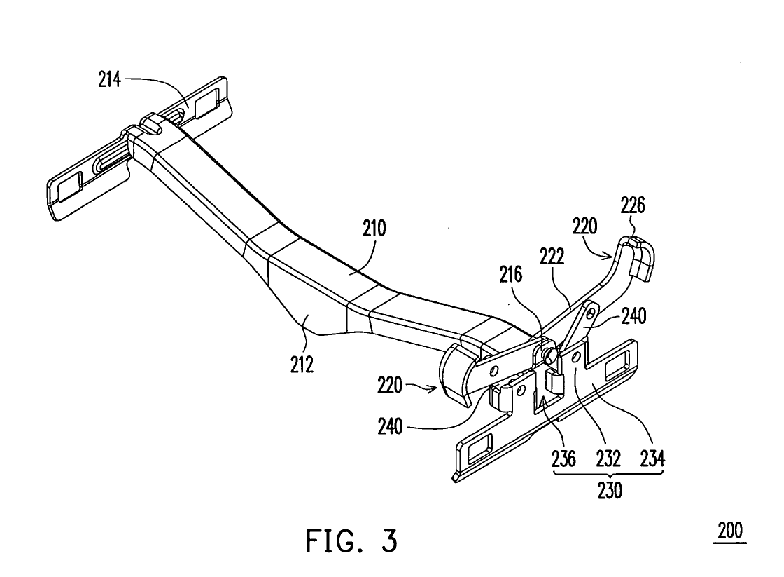

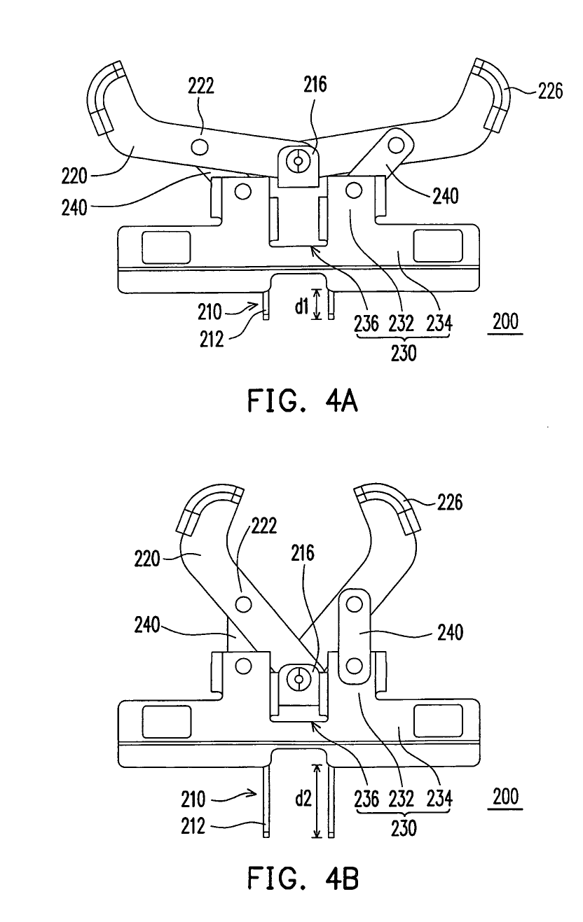

FIG. 3 is a three-dimensional schematic diagram showing the clip module in FIG. 2, and FIG. 4A and FIG. 4B are front views showing the fastener in FIG. 3, which is located at a release position and a locking position, respectively. Please refer to FIG. 2 to FIG. 4B. The clip module 200 includes a body 210, two pressing elements 220, a fastener 230 and two linkage elements 240. The body 210 has a pressing part 212, a third fastening part 214 and a pivot part 216. The pressing part 212 is located between the third fastening part 214 and the pivot part 216 and is suitable to make the heat dissipation element 400 press the heat source 500 (as shown in FIG. 2). The third fastening part 214 is located at one end of the body 210 and is suitable to be fastened to the first fastening part 310 (as shown in FIG. 2) of the base 300, and the pivot part 216 is located at the other end of the body 210.

The pressing element 220 has a first linkage point 222 and a pressing part 226. One end of the pressing element 220 is coupled to the pivot part 216 of the body 210, and the pressing part 226 is located at the other end of the pressing element 220, and the first linkage point 222 is located between the two ends of the pressing element 220. The fastener 230 has two second linkage points 232 which are opposite to each other, a fourth fastening part 234 and a slide slot 236. The fourth fastening part 234 is suitable to be fastened to the second fastening part 320 (as shown in FIG. 2) of the base 300, and the slide slot 236 is located between these second linkage points 232. In addition, the first linkage point 222 of the pressing element 220 is pivotally provided at one end of each linkage element 240 and the second linkage point 232 of the fastener 230 is pivotally provided at the other end of the linkage element 240.

When the clip module 200 is assembled to the base 300 to make the third fastening part 214 of the body 210 and the fourth fastening part 234 of the fastener 230 fastened to the first fastening part 310 and the second fastening part 320 of the base 300, respectively, the pressing part 212 of the body 210 is located above the heat dissipation element 400 (as shown in FIG. 2). At this time, the fastener 230 is located at the release position as shown in FIG. 4A. Then, when a user pushes the pressing elements 220 to make the pressing elements 220 relatively rotate around the pivot part 216 of the body 210 to close, each pressing element 220 can drive the linkage elements 240 to relatively rotate around the second linkage points 232 of the fastener 230 and drive the pivot part 216 of the body 210 to slide in the slide slot 236 of the fastener 230. At this time, the fastener 230 can be moved from the release position shown in FIG. 4A to the locking position shown in FIG. 4B.

In further details, when the fastener 230 is located at the release position shown in FIG. 4A, the relative distance between the bottom of the fastener 230 and the bottom of the pressing part 212 of the body 210 is, for example, d1; when the fastener 230 is located at the locking position shown in FIG. 4B, the relative distance between the bottom of the fastener 230 and the bottom of the pressing part 212 of the body 210 is, for example, d2. However, since the fourth fastening part 234 of the fastener 230 is fastened to the second fastening part 320 of the base 300, the body 210 will bear a downward pressure to make the pressing part 212 move downward, further to fix the heat dissipation element 400 to the heat source 500 when the fastener 230 is moved from the release position to the locking position.

In the embodiment, one end of each pressing element 220 can be connected to the pivot part 216 of the body 210 in a rivet connecting mode or a bolt locking mode to make the pressing elements 220 be suitable to rotate relatively to the pivot part 216 of the body 210. Similarly, two ends of each linkage element 240 can also be connected to the first linkage point 222 of each pressing element 220 and each second linkage element 232 of the fastener 230 in the rivet connecting mode or the bolt locking mode, so that the pressing elements 220 are suitable to rotate relatively to the linkage elements 240 and drive the linkage elements 240 to rotate relatively to the second linkage points 232 of the fastener 230.

In addition, the first fastening part 310 of the base 300 has, for example, two hooks, and the third fastening part 214 of the body 210 has, for example, two fastening holes which are suitable to be fastened to the hooks. The fastening holes are located at, for example, the two opposite ends of the third fastening part 214 to make the connecting position of the pressing part 212 and the third fastening part 214 be located between the fastening holes. Similarly, the second fastening part 320 of the base 300 has, for example, two hooks, and the fourth fastening part 234 of the fastener 230 has, for example, two fastening holes which are suitable to be fastened to the hooks. The fastening holes are located at, for example, the two opposite ends of the fourth fastening part 234 to make the second linkage points 232 of the fastener 230 be located between the fastening holes.

However, the invention is not limited by the above embodiment. For example, the third fastening part 214 of the body 210 and the fourth fastening part 234 of the fastener 230 can have two hooks, respectively, and the first fastening part 310 and the second fastening part 320 of the base 300 can respectively have two fastening holes which are suitable to be fastened to the hooks. The third fastening part 214 of the body 210 and the fourth fastening part 234 of the fastener 230 can also be fastened to the first fastening part 310 and the second fastening part 320 of the base 300 in other modes. In addition, the number of the hooks or the fastening holes of the first fastening part 310, the second fastening part 320, the third fastening part 214 and the fourth fastening part 234 is not limited to be two, and can also be one or more.

To sum up, since the clip module of the invention drives a fastener to move from a release position to a locking position and makes the pressing part of the body move downward to fix a heat dissipation element to a heat source by pushing two pressing elements to relatively rotate, the clip module of the invention has two force applying points and a user can apply force easily and make the clip module uniformly bear the force, and then stresses cannot be concentrated on the two pressing elements, further to enhance the damage resistance of the clip module.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A clip module for fixing a heat dissipation element on a base, the clip module comprising:
a body having a pressing part and a pivot part, wherein the pressing part is used to press the heat dissipation element, and the pivot part is located at one end of the body;
two pressing elements, wherein the pressing element has a first linkage point, and one end of each of the pressing elements is coupled to the pivot part;
a fastener for being fastened to the base and has two second linkage points; and
two linkage elements connecting the first linkage points and the second linkage points, respectively;
wherein the pressing elements rotate around the pivot part to drive the linkage elements to rotate around the corresponding second linkage points so that the fastener is fastened to the base and the pressing part presses the heat dissipation element.

2. The clip module according to claim 1, wherein the base has a first fastening part, and the other end of the body which is opposite to the pivot part has a third fastening part which is fastened to the first fastening part.

3. The clip module according to claim 2, wherein the first fastening part has two hooks, and the third fastening part has two fastening holes which are suitable to be fastened with the hooks.

4. The clip module according to claim 1, wherein the base has a second fastening part, and the fastener correspondingly has a fourth fastening part which is fastened to the second fastening part.

5. The clip module according to claim 4, wherein the second fastening part has two hooks, and the fourth fastening part has two fastening holes which are suitable to be fastened with the hooks.

6. The clip module according to claim 1, wherein the fastener has a slide slot which is located between the linkage points, and the pivot part slides in the slide slot when the pressing elements relatively rotate around the pivot part to make the fastener fastened to the base.
